(19) United States
(12) Patent Application Publication
(10) Pub. No.: US 2011/0080394 A1
(43) Pub. Date: Apr. 7, 2011

(54) DRIVER FOR PLASMA DISPLAY PANEL

(75) Inventors: Dong Kyun Ryu, Seoul (KR); Youn Ik Nam, Suwon (KR); Kyung Hyun Kim, Seoul (KR); Jae Han Yoon, Suwon (KR); Peel Sik Jeon, Hwaseong (KR); Sung Uk Lee, Suwon (KR)

(73) Assignee: Samsung Electro-Mechanics Co., Ltd., Suwon (KR)

(21) Appl. No.: 12/646,498

(22) Filed: Dec. 23, 2009

(30) Foreign Application Priority Data
Oct. 6, 2009 (KR) 10-2009-0094703

(51) Int. Cl. G06F 3/038

(52) U.S. Cl. 345/211

(57) ABSTRACT

There is provided a driver for a plasma display panel that can perform power transmission by setting different paths for an address period and a sustain period. The driver for a plasma display panel may include: a power supply part converting commercial AC power into predetermined driving power; a driving part switching the driving power from the power supply part during the sustain period to supply the switched driving power to the plasma display panel; and a path setting part setting a path through which the driving power from the power supply part is transmitted to the driving part during the sustain period and setting a charging path through which a capacitor is charged with the driving power from the power supply part during the address period.

### CROSS-REFERENCE TO RELATED APPLICATIONS

This application claims the priority of Korean Patent Application No. 10-2009-0094703 filed on Oct. 6, 2009, in the Korean Intellectual Property Office, the disclosure of which is incorporated herein by reference.

### BACKGROUND OF THE INVENTION

1. Field of the Invention

The present invention relates to a driver for a plasma display panel, and more particularly, to a driver for a plasma display panel that can perform power transmission by setting different paths for an address period and a sustain period

2. Description of the Related Art

In general, a plasma display panel includes a plurality of unit cells, each of which includes a front panel, a rear panel and separation walls interposed therebetween. Each unit cell is filled with a main discharge gas, such as neon (Ne) or helium (He), and an inert gas containing a small amount of xenon (Xe). A plurality of unit discharge cells may form a single pixel.

One frame of this plasma display panel is divided into a plurality of sub-fields. The sub-fields are separately driven such that each sub field consists of a rest period during which an entire screen is initialized, an address period during which a discharge cell is selected, and a sustain period during which the discharge of the selected discharge cell is maintained.

During the above-described sustain period, power transmission is performed. However, since the sustain period is the shortest period of time among the reset period, the address period and the sustain period, it is difficult to supply a sufficient amount of power when displaying a screen to which a large load is applied, such as a white screen, and it is also difficult to supply a sufficient amount of power to a large display device.

### SUMMARY OF THE INVENTION

An aspect of the present invention provides a driver for a plasma display panel that sets different paths for an address period and a sustain period to perform power transmission.

According to an aspect of the present invention, there is provided a driver for a plasma display panel driving a plurality of subfields forming a single frame displayed on a screen, the subfields each including a reset period during which a discharge of a plasma display panel is initialized, an address period during which a plasma display panel to be discharged is selected, and a sustain period during which a discharge of the selected plasma display panel is maintained, the driver including: a power supply part converting commercial AC power into predetermined driving power; a driving part switching the driving power from the power supply part during the sustain period to supply the switched driving power to the plasma display panel; and a path setting part setting a path through which the driving power from the power supply part is transmitted to the driving part during the sustain period and setting a charging path through which a capacitor is charged with the driving power from the power supply part during the address period.

The power supply part may include a power conversion unit receiving and switching power to convert the power into the driving power.

The power conversion unit may include: first and second power switches connected in series with each other between two input terminals of input power and alternately switching the input power; and a transformer having a primary winding receiving the power switched by the first and second power switches and a secondary winding forming a turns ratio relative to the primary winding, and converting a voltage level of the switched power according to the turns ratio.

The driving part may include a pair of Y electrode switches having a first Y electrode switch and a second Y electrode switch connected in series with each other, and a pair of X electrode switches connected in parallel with the pair of Y electrode switches and having a first X electrode switch and a second X electrode switch connected in series with each other, and a connection node of the first and second Y electrode switches may be connected to one end of the secondary winding of the transformer and one end of the plasma display panel, and a connection node of the first and second X electrode switches is connected to the other end of the secondary winding and the other end of the plasma display panel.

The path setting part may include: a first switch unit electrically connected to the other end of the secondary winding of the transformer and the connection node of the first and second X electrode switches; a second switch unit electrically connected to the connection node of the first and second Y electrode switches and the one end of the plasma display panel; and a rectification unit connected in parallel with the other end of the secondary winding of the transformer and the first switch unit.

The first switch unit may include first and second switches connected in series with each other, and the rectification unit may include first and second diodes connected in series with each other, and the connection node of the first and second diodes may be electrically connected to the other end of the secondary winding of the transformer.

During the sustain period, when the first power switch is turned on, the second power switch is turned off, and the first and second Y electrode switches and the first and second X electrode switches are turned off, the second switch unit and the second switch of the first switch unit may be closed while the first switch may be opened, so that the driving power from the power conversion unit is supplied to the plasma display panel, and when the first and second power switches are turned off, the first Y electrode switch and the second X electrode switch are turned on, and the second Y electrode switch and the first X electrode switch are turned off, the second switch unit may be closed while the first and second switches of the first switch unit may be opened, so that transmission of the power charged in the capacitor to the transformer is blocked.

During the address period, when the first power switch is turned on, the second power switch is turned off, and the first and second Y electrode switches and the first and second X electrode switches are turned off, the first and second switches of the first switch unit and the second switch unit may be opened while the first and second diodes of the rectification unit may be closed, so that the driving power from the power conversion unit is transmitted to the capacitor, and when the first power switch is turned off, the second power switch is turned on, and the first and second Y electrode switches and the first and second X electrode switches are turned off, the first and second switches of the first switch unit and the second switch unit may be opened while the first and second diodes of the rectification unit may be closed, so that the driving power from the power conversion unit is transmitted to the capacitor.

The power supply may include predetermined inductance, and power remaining after being consumed to drive the plasma display panel may be transmitted to the power supply part due to resonance between the inductance of the power supply part and capacitance of the plasma display panel.

The power conversion unit may perform a switching operation interlocked with a switching operation of the driving part.

The power supply part may further include: a rectifying/smoothing unit rectifying and smoothing the commercial AC power; and a power factor correction unit correcting a power factor of the power from the rectifying/smoothing unit to supply DC power to the power conversion unit.

The inductance may be leakage inductance from the transformer, inductance from an inductor element electrically connected in series between the primary winding and the transformer, or composite inductance of the leakage inductance from the transformer and the inductance of the inductor element.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating the configuration of a driver according to an exemplary embodiment of the present invention; and

FIGS. 2A and 2B are views illustrating the operation of a driver during a sustain period and an address period.

### DETAILED DESCRIPTION OF THE PREFERRED EMBODIMENT

Exemplary embodiments of the present invention will now be described in detail with reference to the accompanying drawings.

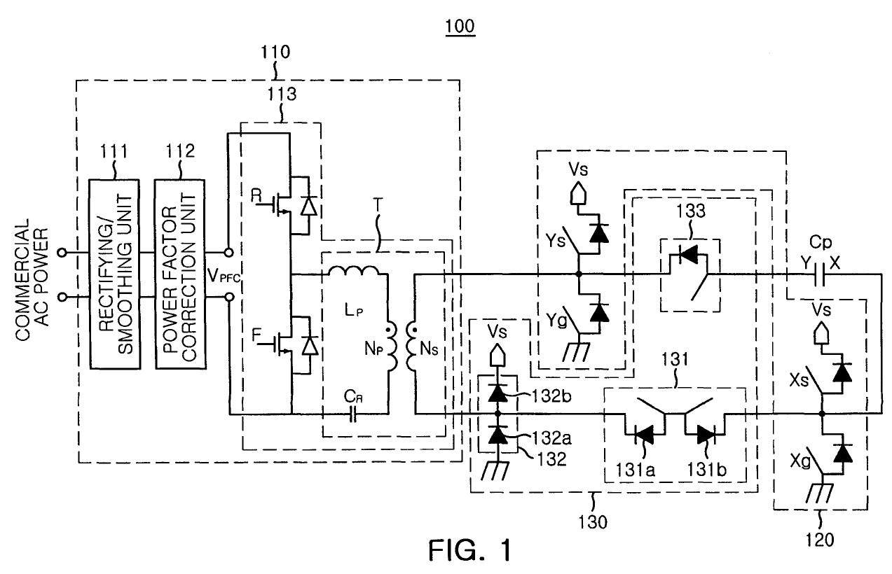

FIG. 1 is a schematic view illustrating the configuration of a driver according to an exemplary embodiment of the invention.

Referring to FIG. 1, a plasma display panel driver 100 according to this embodiment may include a power supply part 110, a driving part 120 and a path setting part 130.

The power supply part 110 converts commercial AC power into driving power having a predetermined voltage level and supplies the driving power to the driving part 120. To this end, the power supply part 110 may include a power conversion unit 113 that switches and converts power. The power supply part 110 may further include a rectifying/smoothing unit 111 that rectifies and smoothes the commercial AC power and a power factor correction unit 112 that corrects a power factor of the rectified and smoothed power to thereby supply DC power to the power conversion unit 113.

The power conversion unit 113 may include half-bridge type first and second power switches R and F and a transformer T. The first and second power switches R and F are connected in series with each other between input terminals of DC power V_{PFC} from the power factor correction unit 112 and alternately switch the DC power V_{PFC}. The transformer T transforms a voltage level of the power switched by the first and second power switches R and F.

The first and second power switches R and F may include body diodes.

The transformer T may include a primary winding Np and a secondary winding Ns each having a predetermined turns ratio. The primary winding Np may be connected in parallel with a second power switch F of the switching circuit 113a. Leakage inductance Lp and capacitance C_{R} may be formed between the primary winding Np and the second power switch F. The leakage inductance Lp may be leakage inductance from the transformer T itself, leakage inductance caused by an inductor element additionally connected, or composite inductance of the leakage inductance from the transformer T itself and the inductance caused by the inductor element additionally connected.

The driving part 120 switches the driving power from the power supply part 110 to supply the switched driving power to a plasma display panel Cp. To this end, the driving part 120 may include a pair of Y electrode switches Ys and Yg and a pair of X electrode switches Xs and Xg each performing a switching operation according to a logic signal S from the outside. Here, the pair of Y electrode switches Ys and Yg and the pair of X electrode switches Xs and Xg may be connected in parallel with each other. The pair of Y electrode switches Ys and Yg may include a first Y electrode switch Ys and a second Y electrode switch Yg connected in series with each other. The pair of X electrode switches Xs and Xg may include a first X electrode switch Xs and a second X electrode switch Xg connected in series with each other. A charging capacitor Vs may be electrically connected to the first Y electrode switch Ys and the first X electrode switch Xs.

The switching operations of the first and second Y electrode switches Ys and Yg and the first and second X electrode switches Xs and Xg are interlocked with the switching operations of the first and second power switches R and F to thereby form an LC resonance path between the leakage inductance Lp of the transformer T and the capacitance Cp of the plasma display panel, so that the remaining power of the driving part 120 is transmitted to the power conversion unit 113 so as to replace the function of an existing Energy Recovery Circuit (ERC).

In general, one screen, displayed on a display device, consists of 30 or 60 frames. Each of the frames, displayed on the screen, has a plurality of subfields. Each of the subfields consists of a reset period during which the discharge of the plasma display panel is initialized, an address period during which a plasma display panel to be discharged is selected, and a sustain period during which the discharge of the selected plasma display panel is maintained.

Individual subfields mayhave different sustain periods, which may require different levels of power. Since power may be insufficient in a specific sustain period, there is a need to set a power transmission path with additional power.

Therefore, the driver 100 according to this embodiment may include a path setting part 130.

The above-described path setting part 130 may include a first switch unit 131, a rectification unit 132 and a second switch unit 133.

The first switch unit 131 may include first and second switches 131a and 131b connected in series with each other. The rectification unit 132 may include first and second diodes 132a and 132b connected in series with each other.

The first switch unit 131 may be electrically connected in series with one end of the secondary winding Ns of the transformer T and a connection node of the first and second X electrode switches Xs and Xg. Each of the first and second switches 131a and 131b of the first switch unit 131 includes a body diode. An anode of the body diode of the second switch 131a may be connected to the body diode of the second switch 131b, while a cathode of the body diode of the second switch 131a may be connected to the rectification unit 132. An anode of the body diode of the second switch 131b may be connected to the anode of the body diode of the second switch 131a. The cathode of the body diode of the second switch 131b may be connected to the connection node of the first and second X electrode switches Xs and Xg.

The connection node of the first and second diodes 132a and 132b of the rectification unit 132 may be connected to one end of the secondary winding Ns of the transformer T and the cathode of the body diode of the second switch 131a.

The second switch unit 133 may be electrically connected between a connection node of the first and second Y electrode switches Ys and Yg and a Y electrode of the plasma display panel. An anode of the body diode of the second switch unit 133 may be connected to the Y electrode of the plasma display panel, while a cathode of the body diode of the second switch unit 133 may be connected to the connection node of the first and second Y electrode switches Ys and Yg.

Hereinafter, the operation of a driver according to an exemplary embodiment of the invention will be described in detail.

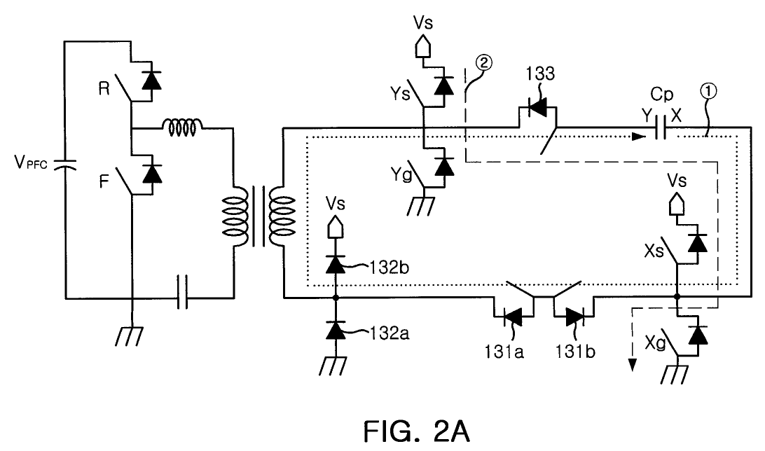

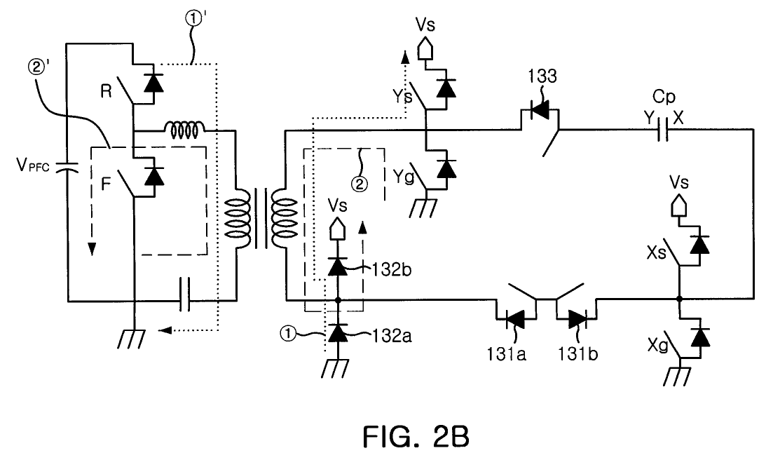

FIGS. 2A and 2B are views illustrating the operation of a driver during a sustain period and an address period according to an exemplary embodiment of the invention.

Referring to FIG. 2A, the driver 100 according to this embodiment may supply power to the plasma display panel Cp during a sustain period to thereby discharge the plasma display panel Cp.

That is, when the first power switch R of the power conversion unit 113 is turned on, the second power switch F thereof is turned off, and the first and second Y electrode switches Ys and Yg and the first and second X electrode switches Xs and Xg of the driving part 120 are turned off, the second switch unit 133 and the second switch 131b of the first switch unit 131 are closed while the second switch 131a is opened, so that the driving power transmitted from the power conversion unit 113 can be supplied to the plasma display panel Cp as indicated by reference numeral \textcircled{1} in FIG. 2A.

In the same manner, when the first and second power switches R and F of the power conversion unit 113 are turned off, the first Y electrode switch Ys and the second X electrode switch Xg are turned on, and the second Y electrode switch Yg and the first X electrode switch Xs are turned off, the second switch unit 133 is closed while the first and second switches 131a and 131b of the first switch unit 131 are opened, the transmission of the power charged in the capacitor Vs to the transformer T may be blocked as indicated by reference numeral \textcircled{2} in FIG. 2A.

On the other hand, as shown in FIG. 2B, the driver 100 according to this embodiment may charge the capacitor Vs with power during the address period.

That is, as indicated by reference numeral \textcircled{1}′ in FIG. 2B, the first power switch R is turned on, the second power switch F is turned off, and the first and second Y electrode switches Ys and Yg and the first and second X electrode switches Xs and Xg are turned off, the first and second switches 131a and 131b of the first switch unit 131 and the second switch unit 133 are opened while the first and second diodes 132a and 132b of the rectification unit 132 are closed, so that the driving power from the power conversion unit 113 can be transmitted to the capacitor Vs as indicated by reference numeral \textcircled{1} in FIG. 2B.

On the other hand, as indicated by reference numeral \textcircled{2}′ in FIG. 2B, when the first power switch R is turned off, the second power switch F is turned on, and the first and second Y electrode switches Ys and Yg and the first and second X electrode switches Xs and Xg are turned off, the first and second switches 131a and 131b of the first switch unit 131 and the second switch unit 133 are opened while the first and second diodes 132a and 132b of the rectification unit 132 are closed, so that the driving power form the power conversion unit 113 can be transmitted to the capacitor Vs as indicated by reference numeral \textcircled{2} in FIG. 2B.

As described above, according to an exemplary embodiment of the invention, as different paths are set so that power can be separately transmitted during an address period and a sustain period, it is possible to supply a sufficient amount of power when displaying a screen to which a large load is applied, such as a white screen, or it is also possible to supply a sufficient amount power to a large display device.

As set forth above, according to exemplary embodiments of the invention, as power transmission is performed by setting different respective paths for an address period and a sustain period, it is possible to supply a sufficient amount of power when displaying a screen to which a large load is applied, such as a white screen, or it is also possible to supply a sufficient amount of power to a large display device.

While the present invention has been shown and described in connection with the exemplary embodiments, it will be apparent to those skilled in the art that modifications and variations can be made without departing from the spirit and scope of the invention as defined by the appended claims.

What is claimed is:

1. A driver for a plasma display panel driving a plurality of subfields forming a single frame displayed on a screen, the subfields each including a reset period during which a discharge of a plasma display panel is initialized, an address period during which a plasma display panel to be discharged is selected, and a sustain period during which a discharge of the selected plasma display panel is maintained, the driver comprising:
a power supply part converting commercial AC power into predetermined driving power;
a driving part switching the driving power from the power supply part during the sustain period to supply the switched driving power to the plasma display panel; and
a path setting part setting a path through which the driving power from the power supply part is transmitted to the driving part during the sustain period and setting a charging path through which a capacitor is charged with the driving power from the power supply part during the address period.

2. The driver of claim 1, wherein the power supply part comprises a power conversion unit receiving and switching power to convert the power into the driving power.

3. The driver of claim 2, wherein the power conversion unit comprises:
first and second power switches connected in series with each other between two input terminals of input power and alternately switching the input power; and
a transformer having a primary winding receiving the power switched by the first and second power switches and a secondary winding forming a turns ratio relative to the primary winding, and converting a voltage level of the switched power according to the turns ratio.

4. The driver of claim 3, wherein the driving part comprises a pair of Y electrode switches having a first Y electrode switch and a second Y electrode switch connected in series with each other, and a pair of X electrode switches connected in parallel with the pair of Y electrode switches and having a first X electrode switch and a second X electrode switch connected in series with each other, and
a connection node of the first and second Y electrode switches is connected to one end of the secondary winding of the transformer and one end of the plasma display panel, and a connection node of the first and second X electrode switches is connected to the other end of the secondary winding and the other end of the plasma display panel.

5. The driver of claim 4, wherein the path setting part comprises:
a first switch unit electrically connected to the other end of the secondary winding of the transformer and the connection node of the first and second X electrode switches;
a second switch unit electrically connected to the connection node of the first and second Y electrode switches and the one end of the plasma display panel; and
a rectification unit connected in parallel with the other end of the secondary winding of the transformer and the first switch unit.

6. The driver of claim 5, wherein the first switch unit comprises first and second switches connected in series with each other, and
the rectification unit comprises first and second diodes connected in series with each other, and the connection node of the first and second diodes is electrically connected to the other end of the secondary winding of the transformer.

7. The driver of claim 6, wherein during the sustain period, when the first power switch is turned on, the second power switch is turned off, and the first and second Y electrode switches and the first and second X electrode switches are turned off, the second switch unit and the second switch of the first switch unit are closed while the first switch is opened, so that the driving power from the power conversion unit is supplied to the plasma display panel, and
when the first and second power switches are turned off, the first Y electrode switch and the second X electrode switch are turned on, and the second Y electrode switch and the first X electrode switch are turned off, the second switch unit is closed while the first and second switches of the first switch unit are opened, so that transmission of the power charged in the capacitor to the transformer is blocked.

8. The driver of claim 6, wherein during the address period, when the first power switch is turned on, the second power switch is turned off, and the first and second Y electrode switches and the first and second X electrode switches are turned off, the first and second switches of the first switch unit and the second switch unit are opened while the first and second diodes of the rectification unit are closed, so that the driving power from the power conversion unit is transmitted to the capacitor, and
when the first power switch is turned off, the second power switch is turned on, and the first and second Y electrode switches and the first and second X electrode switches are turned off, the first and second switches of the first switch unit and the second switch unit are opened while the first and second diodes of the rectification unit are closed, so that the driving power from the power conversion unit is transmitted to the capacitor.

9. The driver of claim 3, wherein the power supply comprises predetermined inductance, and
power remaining after being consumed to drive the plasma display panel is transmitted to the power supply part due to resonance between the inductance of the power supply part and capacitance of the plasma display panel.

10. The driver of claim 2, wherein the power conversion unit performs a switching operation interlocked with a switching operation of the driving part.

11. The driver of claim 2, wherein the power supply part further comprises:
a rectifying/smoothing unit rectifying and smoothing the commercial AC power; and
a power factor correction unit correcting a power factor of the power from the rectifying/smoothing unit to supply DC power to the power conversion unit.

12. The driver of claim 9, wherein the inductance is leakage inductance from the transformer, inductance from an inductor element electrically connected in series between the primary winding and the transformer, or composite inductance of the leakage inductance from the transformer and the inductance of the inductor element.
